(19) United States
(12) Patent Application Publication
(10) Pub. No.: US 2022/0201054 A1
(43) Pub. Date: Jun. 23, 2022

(54) METHOD AND APPARATUS FOR CONTROLLING RESOURCE SHARING IN REAL-TIME DATA TRANSMISSION SYSTEM

(71) Applicants: Penta Security Systems Inc., Seoul (KR); PAUST Inc., Pohang si (KR)

(72) Inventors: Gyu Ho LEE, Seoul (KR); Hyun Jae PARK, Seoul (KR); Min Woo NAM, Bucheon-si (KR); Sang Gyoo SIM, Seoul (KR); Hyun Ho SHIN, Incheon (KR); Duk Soo KIM, Seoul (KR); Seok Woo LEE, Seoul (KR)

(21) Appl. No.: 17/138,331

(22) Filed: Dec. 30, 2020

(30) Foreign Application Priority Data
Dec. 21, 2020 (KR) 10-2020-0180078

(51) Int. Cl. H04L 29/06; G06F 9/50; G06F 9/38; H04W 72/04

(52) U.S. Cl. CPC H04L 65/4084; H04W 72/0406; G06F 9/3851; G06F 9/5011

(57) ABSTRACT

The present disclosure provides an apparatus and method of controlling a resource sharing in a real-time data transmission network which can increase a network efficiency by decentralizing data operation loads and reducing duplicate operations. The resource sharing control device is one of a plurality of devices included in a real-time data transmission system which delivers transmit data provided by a data producer to a data consumer. At least one instruction when executed by the processor causes the processor to: establish a delivery path passing at least some of the plurality of resource sharing control devices in the real-time data transmission system and through which the transmit data is delivered; and decompose an operation to be performed on the transmit data into a plurality of partial operations and allocate each of the partial operations to one or more of the plurality of resource sharing control devices on the delivery path.

### CROSS-REFERENCE TO RELATED APPLICATION

The present application claims priority to Korean Patent Application No. 10-2020-0180078, filed on Dec. 21, 2020, in the Korean Intellectual Property Office, which is incorporated herein in its entirety by reference.

### TECHNICAL FIELD

The present disclosure relates to a routing apparatus and method in a data transmission network and, more particularly, to an apparatus and method of optimizing routing in a streaming network by dynamically reconfiguring a transmission path depending on network loads.

### BACKGROUND

Streaming, which is an alternative to file downloading, is a method of delivering a content or data file such that the content or data file is segmented and continuously transmitted to a client. Traditionally, the streaming has been used to distribute multimedia or video contents to consumers, and its use has been steadily increasing in a peer-to-peer (P2P) network. Recently, however, demands for the streaming and P2P services are increasing for various data files other than the multimedia contents. For example, expanding are small data segments traffic transmitted by various sensors or Internet-of-Things (IoT) devices in P2P networks connecting a plurality of devices or nodes associated with a smart city, a smart factory, and autonomous vehicles. Accordingly, continuous transmission of the small data segments are gradually increasing. In addition, due to an expansion of distributed parallel computing frameworks such as MapReduce and Apache Hadoop and computing clusters, the divisional transmission of segmented data is expected to increase significantly in the future.

Regardless of data types, i.e. multimedia or general data, the divisional transmission of segmented data enables an operation or manipulation of data in a course of the transmission over the network. In addition, data may be temporarily stored while passing through a plurality of servers or nodes within the network. Conventionally, however, computing loads may be concentrated on some of the nodes because the operations or storing processes may be performed in nodes adjacent to data consumers among the plurality of nodes in the network. Further, a plurality of nodes may perform the same operation or storing process duplicately, and the overall efficiency of the network may be low.

### SUMMARY

Provided are an apparatus and method of controlling a resource sharing, in a real-time data transmission network transmitting P2P service data, which can increase a network efficiency by decentralizing data operation loads and reducing duplicate operations.

According to an aspect of an exemplary embodiment, a resource sharing control device is one of a plurality of resource sharing control devices included in a real-time data transmission system which delivers transmit data provided by a data producer to a data consumer. The resource sharing control device includes: a processor; and a memory storing at least one instruction to be executed by the processor. The at least one instruction when executed by the processor causes the processor to: establish a delivery path passing at least some of the plurality of resource sharing control devices in the real-time data transmission system and through which the transmit data is delivered; and decompose an operation to be performed on the transmit data into a plurality of partial operations and allocate each of the partial operations to one or more of the plurality of resource sharing control devices on the delivery path.

The at least one instruction may include: instructions when executed by the processor causes the processor to receive the transmit data and output the transmit data or operation result data obtained by performing the operation on the transmit data to the data consumer device or another resource sharing control device.

The at least one instruction causing the processor to establish the delivery path may include instructions to establish the delivery path such that a distance from the producer device and the consumer device is minimized.

The at least one instruction causing the processor to establish the delivery path may include instructions to: check status information of other nearby resource sharing control devices; and establish the delivery path based on the status information.

The at least one instruction causing the processor to establish the delivery path may include instructions to: check delays in other nearby resource sharing control devices; and establish the delivery path such that the delays are minimized.

The at least one instruction causing the processor to allocate each of the partial operations may include instructions to allocate each of the partial operations to one or more of the plurality of resource sharing control devices on the delivery path such that duplicate operations in the real-time data transmission system are minimized.

The at least one instruction causing the processor to allocate each of the partial operations may include instructions to receive a request for registration of the operation from the consumer device.

The at least one instruction may include instructions when executed by the processor causes the processor to: adjust the delivery path and the allocation result to optimize the delivery path and the allocation result after allocating each of the partial operations to the one or more resource sharing control devices.

The at least one instruction may include instructions when executed by the processor causes the processor to: collecting status information of nearby resource sharing control devices; and share the status information with other resource sharing control devices.

According to another aspect of an exemplary embodiment, a resource sharing control method is implemented in a real-time data transmission system having a plurality of resource sharing control devices to deliver transmit data provided by a data producer to a data consumer. The resource sharing control method includes: (a) determining resources required for handling the transmit data; (b) establishing a delivery path passing at least some of the plurality of resource sharing control devices in the real-time data transmission system and through which the transmit data is delivered; and (c) decomposing an operation to be performed on the transmit data into a plurality of partial operations and allocating the partial operations to one or more of the plurality of resource sharing control devices on the delivery path.

The resource sharing control method may further include: (d) receiving the transmit data and outputting the transmit data or operation result data obtained by performing the operation on the transmit data to the data consumer device or another resource sharing control device.

In the step (b), the delivery path may be established such that a distance from the producer device and the consumer device is minimized.

The step (b) may include: checking status information of other nearby resource sharing control devices; and establishing the delivery path based on the status information.

The step (b) may include: checking delays in other nearby resource sharing control devices; and establishing the delivery path such that the delays are minimized.

In the step (c), each of the partial operations may be allocated to one or more of the plurality of resource sharing control devices on the delivery path such that duplicate operations in the real-time data transmission system are minimized.

The resource sharing control method may further include: (d) adjusting the delivery path and the allocation result to optimize the delivery path and the allocation result.

The step (c) may include: receiving a request for registration of the operation from the consumer device.

According to an embodiment of the present disclosure, data operation loads can be decentralized to more nodes and duplicate operations can be reduced in a real-time data transmission network including a plurality of nodes and transmitting P2P service data. Accordingly, it is possible to prevent concentration of loads on nodes receiving streaming requests from clients or other nodes. In addition, the network efficiency can be increased, and the number of users who can simultaneously use the data services can be increased under a condition of the same computing power and bandwidth.

Such a data transmission system can handle various types of data such as IoT data, web events, sensor data, media data, data transaction logs, and system logs. The data transmission system is applicable to various fields such as weather forecasting, live media streaming, delivering traffic information, transferring real-time monitoring information, and forecasting.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 a schematic illustration of a data transmission system according to an embodiment of the present disclosure;

FIG. 2 illustrates an example of a path established between a data producer device and a data consumer device;

FIGS. 3A and 3B are diagrams showing a possibility of duplicate operations depending on a selection of nodes performing the operations in a broker network;

FIG. 4 is a functional block diagram of each node in the broker network according to an embodiment of the present disclosure;

FIG. 5 is an illustration of an example of an interconnection between a manager node and a worker node in a broker network according to an embodiment of the present disclosure;

FIG. 6 is a functional block diagram of a scheduling engine in the manager node according to an embodiment of the present disclosure;

FIG. 7 is a flowchart showing an example of a process of path setting and resource allocation scheduling in a data transmission system according to an embodiment of the present disclosure;

FIG. 8 is a flowchart showing the path setting process in detail;

FIG. 9 is a flowchart showing a process of registering and executing an operation process according to an embodiment of the present disclosure;

FIG. 10 is a schematic diagram depicting the process of registering and executing an operation;

FIG. 11 is a flowchart showing a process of expanding the broker network according to an addition of a new node; and

FIG. 12 is a physical block diagram of each node according to an embodiment of the present disclosure.

The drawings described herein are for illustration purposes only and are not intended to limit the scope of the present disclosure in any way.

### DETAILED DESCRIPTION

For a more clear understanding of the features and advantages of the present disclosure, exemplary embodiments of the present disclosure will be described in detail with reference to the accompanied drawings. However, it should be understood that the present disclosure is not limited to particular embodiments and includes all modifications, equivalents, and alternatives falling within the idea and scope of the present disclosure. In describing each drawing, similar reference numerals have been used for similar components.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure.

The terminologies are used herein for the purpose of describing particular embodiments only and are not intended to limit the disclosure. The singular forms include plural referents unless the context clearly dictates otherwise. Also, the expressions “˜comprises,” “˜includes,” “˜constructed,” “˜configured” are used to refer a presence of a combination of enumerated features, numbers, processing steps, operations, elements, or components, but are not intended to exclude a possibility of a presence or addition of another feature, number, processing step, operation, element, or component.

The terms used in this application are only used to describe certain embodiments and are not intended to limit the present disclosure. As used herein, the singular expressions are intended to include plural forms as well, unless the context clearly dictates otherwise. It should be understood that the terms “comprise” and/or “comprising”, when used herein, specify the presence of stated features, integers, steps, operations, elements, components, or a combination thereof but do not preclude the presence or addition of one or more features, integers, steps, operations, elements, components, or a combination thereof.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with meanings in the context of related technologies and should not be interpreted as having ideal or excessively formal meanings unless explicitly defined in the present application.

Hereinafter, embodiments of the present disclosure will be described in more detail with reference to the accompanying drawings. In describing the present disclosure, in order to facilitate an overall understanding thereof, the same components are assigned the same reference numerals in the drawings and are not redundantly described here. Hereinafter, embodiments of the present disclosure will be described in detail with reference to the accompanying drawings.

In the following description and the accompanied drawings, detailed descriptions of well-known functions or configuration that may obscure the subject matter of the present disclosure will be omitted for simplicity. Also, it is to be noted that the same components are designated by the same reference numerals throughout the drawings.

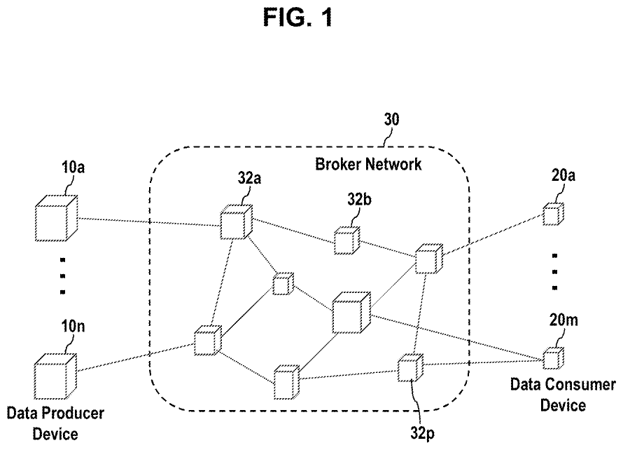

FIG. 1 a schematic illustration of a data transmission system according to an embodiment of the present disclosure.

The data transmission system shown in the drawing includes at least one data producer device (hereinbelow referred to as ‘producer’) 10A-10N, a plurality of data consumer devices (hereinbelow referred to as ‘consumers’) 20A-20M, and a broker network 30 providing a path between the producer 10A-10N and one of the consumers 20A-20M. In the data transmission system, which may be a system delivering point-to-point (P2P) service data, the devices performing the roles of the producers 10A-10N and the devices performing the roles of the consumers 20A-20M may be interchanged. Also, some of the producers 10A-10N and the consumers 20A-20M may be joined to the broker network 30, and some of nodes in the broker network 30 may act as the producers or the consumers.

Each of the producers 10A-10N may generate original data and provide the original data to the consumers 20A-20M through the broker network 30. In the course of providing the data, the producers 10A-10N may partition the original data to provide the consumers 20A-20M with the data in a form of a data stream. Examples of the original data may include multimedia contents such as a moving picture, data files, application programs, and sensor data, but the present disclosure is not limited thereto. Although the expression “producer” is used in this specification, the original data provided by the producers 10A-10N is not limited to that created by the produders 10A-10N or the operators thereof, but may be created by other entities. Each of the producers 10A-10N may have a policy for additional replication and partitioning, in the broker network 30, of the original data or any data partitioned therefrom. Each of the producers 10A-10N may be a personal terminal such as a personal computer (PC) or a smartphone, or may be a server device. Also, each of the producers 10A-10N may be an application program executed in such a device.

Each of the consumers 20A-20M receives data pushed from any of the producers 10A-10N through the broker network 30 and consumes the received data. The specific method of “consuming” the data may be different for each type of data. Each of the consumers 20A-20M may set a policy for a period of receiving data of the same data type. The policy may be useful when the topic of the data is something that needs a periodic update, such as in sensor data or weather forecasts. Each of the consumers 20A-20M may be a personal terminal such as a PC or a smartphone. Also, each of the consumers 20A-20M may be an application program executed in such a device.

The broker network 30 may be a kind of overlay network that is configured on a public network such as Internet, and may include a plurality of node devices 32A-32P (hereinbelow referred to as ‘nodes’) that can be connected logically to each other. That is, the plurality of nodes 32A-32P may form the broker network 30 to deliver data requested by a consumer 20A-20M, for example, from one or more producers 10A-10N to a corresponding consumer 20A-20M. The producers 10A-10N or the consumers 20A-20M need not designate one or more nodes 32A-32P in the broker network to include in a delivery path, but an optimal path through one or more nodes 32A-32P is established automatically. Each of the nodes 32A-32P can temporarily store data according to a preset policy. Each of the nodes 32A-32P may be implemented by a server device, for example.

Hereinbelow, the producers 10A-10N will be collectively referred to as the ‘producer 10’, the consumers 20A-20M will be collectively referred to as the ‘consumer 20’, and the nodes 32A-32P will be collectively referred to as the ‘node 32’, as necessary.

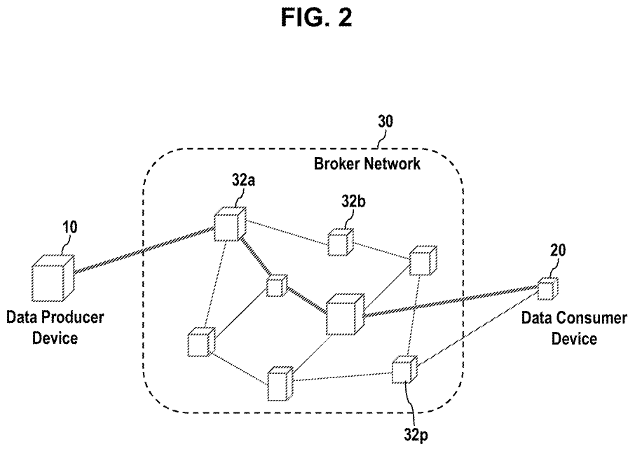

The broker network 30 according to the present disclosure may establish an appropriate data delivery path according to situations of the producer 10 and the consumer 20. FIG. 2 illustrates an example of the path established between producer 10 and consumer 20. A setting of the path may be carried out in consideration of a status of resources such as the usage of a CPU and memory in each of the nodes 32A-32P, distances between the nodes, and a distance between the producer 10 and the consumer 20 according to each potential path. The optimal path may be established such that the distance between the producer 10 and the consumer 20 is minimized while decentralizing the roles of the nodes 32A-32P dynamically, for example. It is be noted that the term “distance” in this specification, including the claims, does not refer to a physical distance between two devices, but refers to a quantity measured based on data processing time and/or an amount of resources required for the data processing.

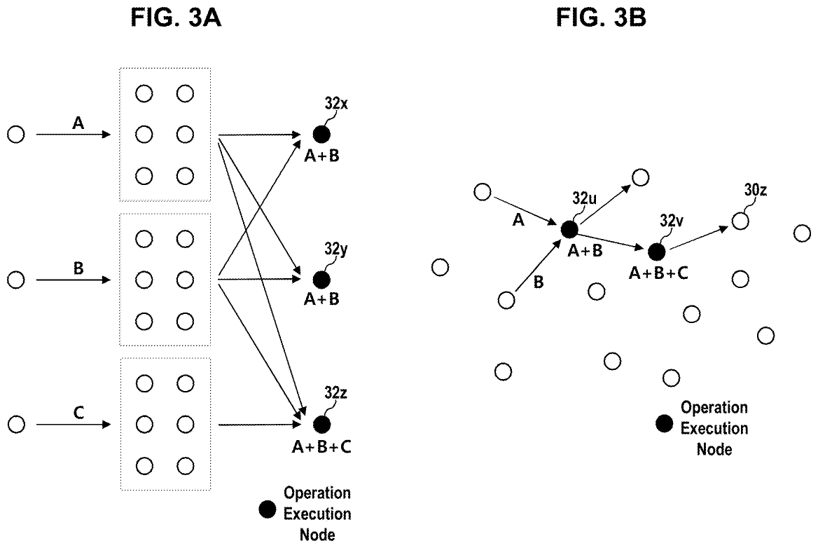

When operations are required in the delivery process in the broker network 30, the setting of the path may be performed such that a number of duplicate operations is be reduced. For example, in case that all operations are performed at final nodes 32X, 32Y, or 32Z which deliver data to the consumers 20 as shown in FIG. 3A, the operation ‘A+B’ is performed three times at the three nodes 32X, 32Y, and 32Z. Contrarily, if a common operation of ‘A+B’ is performed at a node 32U and another operation of ‘+C’ is performed at another node 32V in the broker network 30 as shown in FIG. 3B according to an embodiment of the present disclosure, the number of the duplicate operations can be greatly reduced and a resource usage can be minimized.

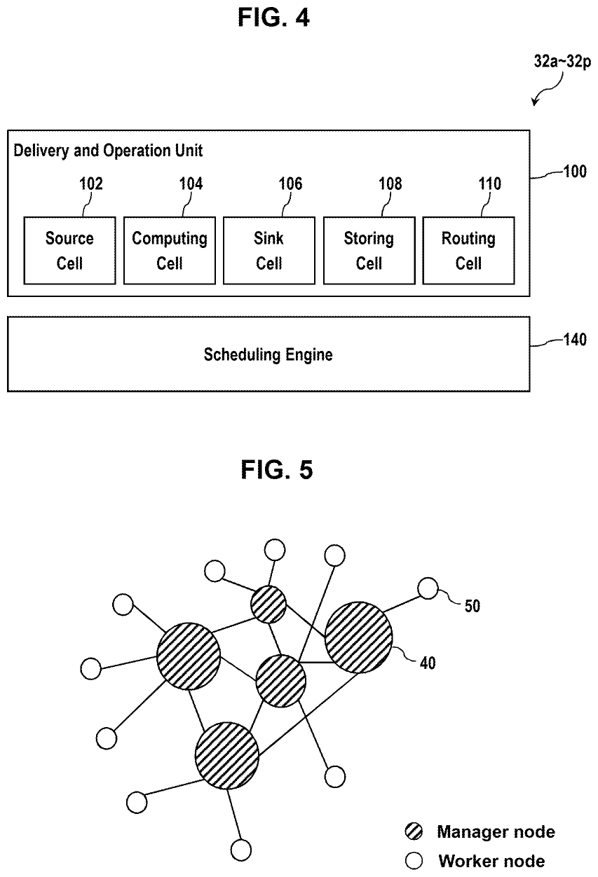

FIG. 4 is a functional block diagram of each of the nodes 32A-32P in the broker network 30 according to an embodiment of the present disclosure. Each of the nodes 32A-32P may include a delivery and operation unit 100 and a scheduling engine 140.

The delivery and operation unit 100 receives data from one of the producers 10A-10N or one of the other nodes 32A-32P in the broker network 30, performs necessary operations, and then transmits the received data or an operation result data to one of the consumers 20A-20M or another node in the broker network 30.

In an exemplary embodiment, the delivery and operation unit 100 may include a source cell 102, a computing cell 104, a sink cell 106, a storing cell 108, and a routing cell 110. Each of the cells 102-110 may be program instructions stored in a memory and executable by a processor or processes implemented by the program instructions. Each cell is assigned a role according to a specific situation during a procedure of processing the streaming data.

The source cell 102 receives the streaming data transmitted by the producers 10A-10N to transfer to the computing cell 104, the sink cell 106, or the storing cell 108. The source cell 102 may adjust a processing order and a back pressure of the data when a data processing speed in a subsequent cell or a subsequent node is slower than a data inflow rate.

The computing cell 104 performs an operation on the streaming data received from the source cell 102 and transfers the operation result data to the sink cell 106, the storing cell 108, or a subsequent node.

The sink cell 106, which may be activated only in a node immediately before a consumer 20, finally combines the streaming data received through the source cell 102 or the streaming data received from another node and outputs combined data to the consumer 20. The sink cell 106 may adjust a processing order and a back pressure of the data when a data processing speed in the consumer 20 is slower than a data inflow rate in the sink cell 106.

The storing cell 108 may store data received from the source cell 102, the computing cell 104, or another node in a memory or a storage device. The memory may be used to temporarily store a small amount of data or for a short period of time. On the other hand, the storage device may be used to store a relatively larger amount of data, than the memory, for a relatively long period of time.

The routing cell 110 may communicate periodically or aperiodically with routing cells of neighboring nodes to check latencies in the neighboring nodes, and may coordinate with the neighboring nodes to establish the path for the data while minimizing the latencies. Though the routing cell 110 is provided separately from the scheduling engine 180 in an exemplary embodiment, the routing cell 110 may be integrated with the scheduling engine 180 in an alternative embodiment.

Among the cells 110 through 120 of the delivery and operation unit 100 described above, the routing cell 110 may be implemented by program instructions that are always executed as long as the node is turned on and the operation according to the present disclosure is being performed. However, the cells other than the routing cell 110, that is, the source cell 102, the computing cell 104, the sink cell 106, and the storing cell 108 may be active only when there are necessary. That is, those cells may be executed under a control of the scheduling engine 140 only when they are necessary, but may be terminated or remain in a sleep mode when there is no task to be performed.

The scheduling engine 140 may collects and manages status information of the cells 102-110. Here, the status of a cell may include information on whether the cell is activated or not, amount of resources being used by the cell, and a task being performed by the cell. The ‘task’ may include relaying of transmit data being delivered from the producer to the consumer, temporarily storing of the transmit data, and an operation to be performed on the transmit data. In addition, the term ‘information on a task’ may include detailed information on the transmit data (i.e., information on the producer of the data being received by the source cell, the consumer which will receive the transmit data, and the nodes which the transmit data passes), information about types of the operations performed by the operation cell and operands of the operations, for example.

Also, the scheduling engine 140 may manage life cycles of cells other than the routing cell 110, that is, the source cell 102, the computing cell 104, the sink cell 106, and the storing cell 108. In other words, the scheduling engine 140 may wake up or executes each of the cells when there occurs a task to be performed by the cell, and causes the cell to be terminated or to the sleep mode when there is no task to be performed by the cell.

In addition, the scheduling engine 140 may communicate with scheduling engines of neighboring nodes to obtain status information such as a resource usage, a computing load, and a communication bandwidth in use in each of the nodes. The scheduling engine 140 may adjust the operations of the cells 102-110 in the corresponding node based on the status information of the neighboring nodes. As described above, the scheduling engine 140, which may be a rule-based engine, may dynamically allocate roles of the cells according to the status of the resources of the node and the neighboring nodes and generate the optimal path for streaming data.

According to an exemplary embodiment of the present disclosure, the nodes 32A-32P in the broker network 30 can be classified, according to their functionalities, into two categories: a manager node and a worker node. FIG. 5 shows an example of an interconnection between the manager nodes 40 and the worker nodes 50 in the broker network 30. As shown in the drawing, each of the manager nodes 40 may be connected to one or more manager nodes and one or more worker nodes 50.

The manager node 40 may collect and manage the status information of other manager nodes and the status information of the worker nodes that are connected to or can be connected to the manager node. The manager node 40 may assign a task to the worker node 50. The manager node 40 may store the status information of the nodes to be safe from a single point of failure through a pBFT (practical byzantine fault tolerance) series algorithm similarly to a blockchain. That is, the broker network 30 according to an exemplary embodiment of the present disclosure has a decentralized architecture in which global status information for all nodes is distributed and stored in a plurality of manager nodes.

The worker node 50 provides the manager node 40 with the available resources and the status information of the cells of the node itself. Also, the worker node 50 may be assigned with the task by the manager node 40 to execute the task through its cells.

Meanwhile, a worker node 50 may be changed into a manager node 40 and a manager node 40 may be changed into a worker node 50 according to overall loads of the broker network 30. In particular, in case that any of the manager nodes 40 becomes inoperative due to an error, one of the worker nodes 50 may be set as the manager node 40 through an agreement of the other manager nodes.

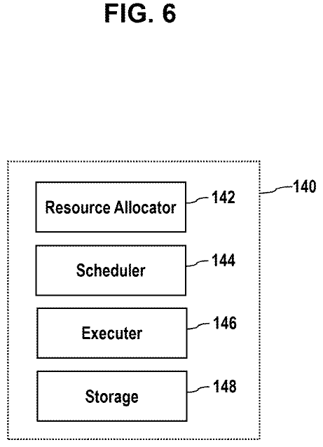

FIG. 6 is a functional block diagram of the scheduling engine 140 in the manager node 40 according to an exemplary embodiment of the present disclosure. The scheduling engine 140 may include a resource allocator 142, a scheduler 144, an executer 146, and a storage 148.

The resource allocator 142 may generate tasks by decomposing a data request received from a client such as the consumers 20A-20M and the producers 10A-10N or combining the requests, and may calculate resources required to perform the generated tasks.

The scheduler 144 may collect and manage the status information of the cells 102-110 in the node. Also, the scheduler 144 may share the global status information with the schedulers of the other manager nodes 40 and may share the tasks with the schedulers of the other manager nodes 40. Here, the global status information may include information on the resources of each manager node 40 and the worker nodes connected thereto and the tasks to be performed. The tasks to be performed may include the tasks generated in the manager node itself and the tasks allocated by the other manager nodes. In addition, the scheduler 144 may determine to perform at least some of the tasks in the manager node by itself and allocate remaining tasks to the worker nodes 50 connected to the manager node.

The executer 146 is a container that executes the tasks to be performed in the manager node by itself, i.e., by the cells in the node. The executer 146 manages the life cycles of cells in the node other than the routing cell 110, i.e. the source cell 102, the computing cell 104, the sink cell 106, and the storing cell 108, and controls the operation of the cells.

The storage 148 stores the status information received from the cells in the node. The storage 148 may further store the status information on the other nodes such as the other manager nodes and at least some of the worker nodes. The storage 148 may be constructed in a form of a regular database or may have a form of a simplified database having no schema.

Meanwhile, the worker node 40 may be configured similarly to the manager node 40 shown in FIG. 6. In a course of the operation of the worker node 40, only the executer 146 and the storage 148 may play the main roles in the worker node 40. However, considering that the worker node 50 may be changed into the manager node 40 as necessary as mentioned above, it is desirable that the worker node 40 has a configuration similar to that of the manager node 40.

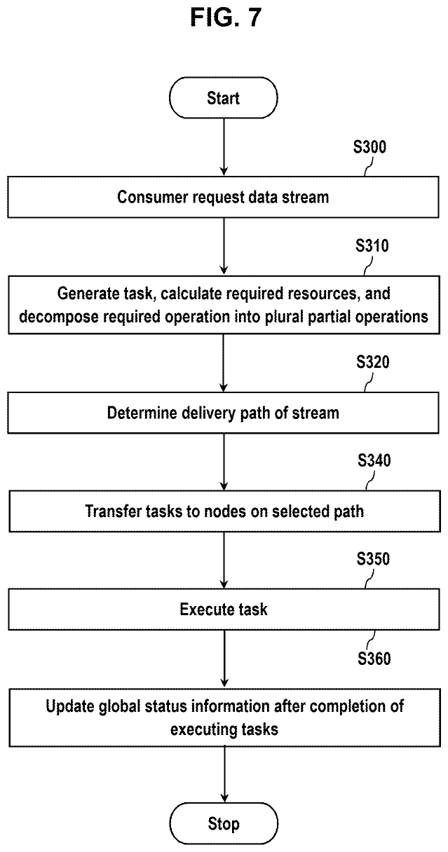

FIG. 7 is a flowchart showing an example of an overall operation of a data transmission system according to an exemplary embodiment of the present disclosure.

First, a user of the consumer 20 may request a data stream through the corresponding device (step 300). The request for the data stream may be submitted, for example, in an application program associated with a specific topic running on the consumer device. The recipient of the request for the data stream may be a predetermined producer 10A-10N or any of the nodes 32A-32P. In an exemplary embodiment, the request for the data stream may be transmitted to a producer 10A-10N or a node 32A-30P having an IP address or URL prescribed in advance in the application program running in the consumer 20. In another exemplary embodiment, the request for the data stream may be transmitted from the consumer to a producer 10A-10N or a node 32A-30P hyperlinked from a data stream request item. Meanwhile, the request for the data stream may include a weighting factor indicating a weighting ratio of policies selected by the consumer 20 or another entity among conflicting policies of saving resources and minimizing latency, for example. The weighting factor may affect a data transmission speed and a bandwidth of the transmit data.

The node 32A-32P receiving the request for the data stream may be the manager node 40, but may be the producer 10A-10N or the worker node 50. In case that the node 32A-32P receiving the request for the data stream is the producer 10A-10N or the worker node 50, the producer or the worker node may transfer the request for the data stream to any one of the manager nodes 40. The manager node 40 having received the request for the data stream directly from the consumer 20A-20M or via the producer 10A-10N or the worker node 50 may initiate the process of path setting and resource allocation.

The resource allocator 142 of the manager node 40 may generate the tasks for processing the request for the data stream and calculate the resources required to perform the tasks. Also, in case that an operation is required in a course of processing the request for the data stream, the resource allocator 142 may decompose the required operation into a plurality of partial operations so as to reinterpret the required operation into a combination of the partial operations, i.e. an operation sequence. The resource allocator 142 transfers the information on the necessary resources and the information on the operation sequence to the scheduler 144 (step 310).

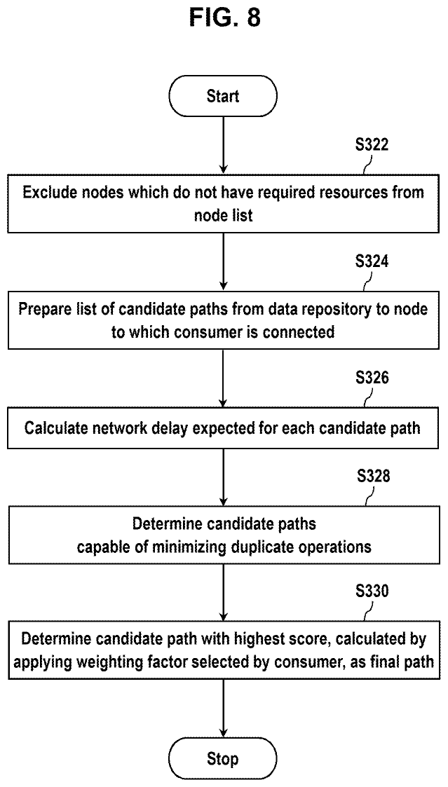

Subsequently, the scheduler 144 of the manager node 40 may determine a delivery path of the stream based on the status information of the other manager nodes and the worker nodes stored in the storage 148 (step 320). FIG. 8 shows the path setting process of the step 320 in detail. Referring to FIG. 8, the path determination process will be described in more detail.

In step 322, the scheduler 144 may exclude nodes which do not have required resources from a node list including the other manager nodes and the worker nodes.

In step 324, the scheduler 144 may acquire information on a data repository in which the data associated with the current topic is stored—that is, one or more of the nodes and the producers 10A-10N—and prepare a list of candidate paths from the repository to nodes to which the consumers 20A-20M having requested the data stream are connected. At this time, the scheduler 144 may select only the paths having capabilities to perform the operation sequence as the candidate paths.

In step 326, the scheduler 144 obtains, from the routing cell 110, information on an expected delay in each node and an expected delay required for a transmission of the data between the nodes to calculate a network delay expected for each candidate path.

In step 328, the scheduler 144 determines candidate paths capable of minimizing duplicate operations based on information on operations that are already being executed or to be executed in the nodes existing on each of the candidate paths.

In step 330, the scheduler 144 calculates a score for each candidate path by applying the weighting factor selected by the consumer 20A-20M while the consumer 20A-20M requested the data stream, and selects a candidate path with a highest score as a final path.

Referring back to FIG. 7, after the final path is selected, the scheduler 144 transfers tasks to executers 146 of the nodes on the selected path (step 340).

The executer 146 executed the task by controlling the operation of cells in the node (step 350). Upon completion of the execution of the task, the executer 146 notifies the scheduler 144 of the node to which it belongs that the execution of the task is completed.

The scheduler of each node provides the manager node having initiated the process of path setting and resource allocation with information that the execution of the task is successfully completed and the information about the remaining resources in the current node. The scheduler of the manager node updates the global status information by sharing the information with other the manager nodes (step 360).

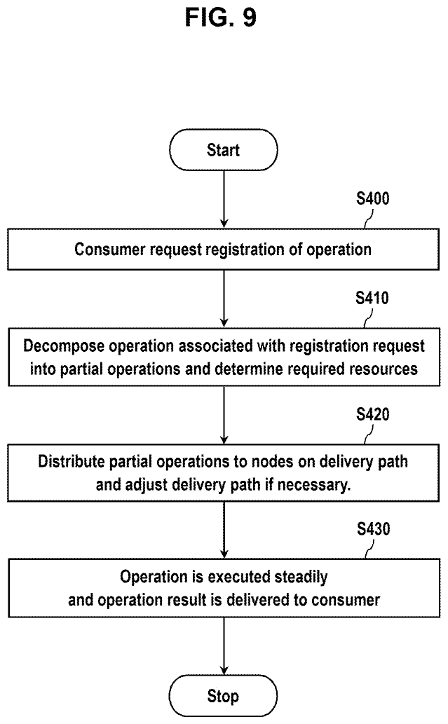

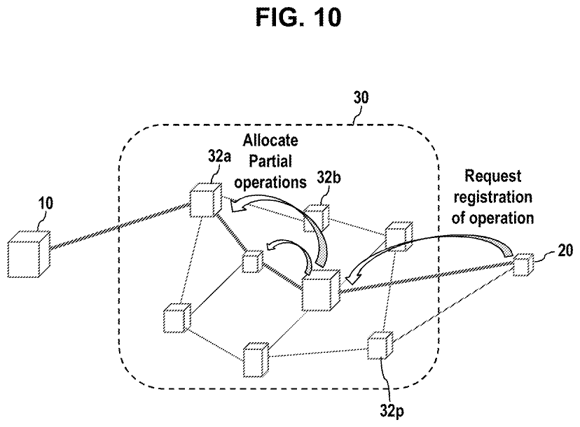

According to the embodiment shown in FIG. 7, required operations may be performed in a course of processing the request for the data stream from the consumers 20A-20M. In an alternative embodiment, however, the consumers 20A-20M may register an operation desired to be executed on the data stream, so that registered operation is performed for the data stream. FIGS. 9 and 10 show such an embodiment. FIG. 9 is a flowchart showing a process of registering an operation and executing a registered operation according to an embodiment of the present disclosure. FIG. 10 is a schematic illustration of an operation registration and executing the registered operation.

First, a consumer 20A-20M may request a registration of an operation (step 400). The registration of the operation can be made, for example, in an application program for a specific topic that is being executed on the consumer device. A request for the registration of the operation may be made together with the request for the data stream, but may be made independently from the request for the data stream as well.

In the present specification, including the claims, the term “operation” refers to an editing and manipulation of data such as a merging, rearrangement, format conversion, truncation, partial deletion, downsampling, concatenation, time windowing of segmenting the data in units of a certain time period, and so on. An example of such an operation may include combining a plurality of surveillance camera images into a single image, and adding a caption or pointer into the surveillance camera image. Another example of the operation may include collecting a plurality of sensor signals to display in one image. Another example of the operation may include lowering resolution of a moving picture in consideration of a resolution of a display device or a bandwidth of the consumer device 20. Another example of the operation may include an application of a subtitle provided by a producer to a moving picture provided by another producer. Another example of the operation may include distributing a video stream to two or more consumers 20A-20M with a permission of the producer or another authorized entity.

The resource allocator 142 of a manager node 40 may receive the request for the registration of the operation from the consumer 20 directly or via the producer or another node to decompose the operation associated with the request into a plurality of partial operations. The resource allocator 142 may transfer information on the resources required to perform the plurality of partial operations, i.e. the operation sequence, and the information on the partial operations to the scheduler 144 (step 410).

The scheduler 144 of the manager node 40 may distribute each partial operation of the operation sequence to the nodes on the delivery path of the stream related to the operation (step 420). At this time, in case that there is any node which do not have sufficient resources, the delivery path of the stream may be adjusted.

After the operation is registered as described above and at least one subject to perform the operation is determined, the operation may be executed steadily unless a separate operation or an event to stop the streaming occurs, and the consumer 20 having requested the registration of the operation can receive the operation result data (step 430).

On the other hand, proprietary rights for the original data provided by the producers 10A-10N are reserved to the right holder, and information of the proprietary rights may be distributed and stored in all the nodes or some of the nodes. In case that a consumer who does not have an authority to acquire the original data requests the registration of the operation with an intention of obtaining a copy of the original data, the scheduling engine 140 of the node receiving the request may detect a duplication attempt based on an impure intention at a low level such as an opcode level, for example, and block the registration of a corresponding operation.

The data transmission system according to the present disclosure is highly scalable. Preparations for installing new nodes additionally may be completed simply by installing a resource sharing client program for implementing the present disclosure and activating the program in each of the new nodes.

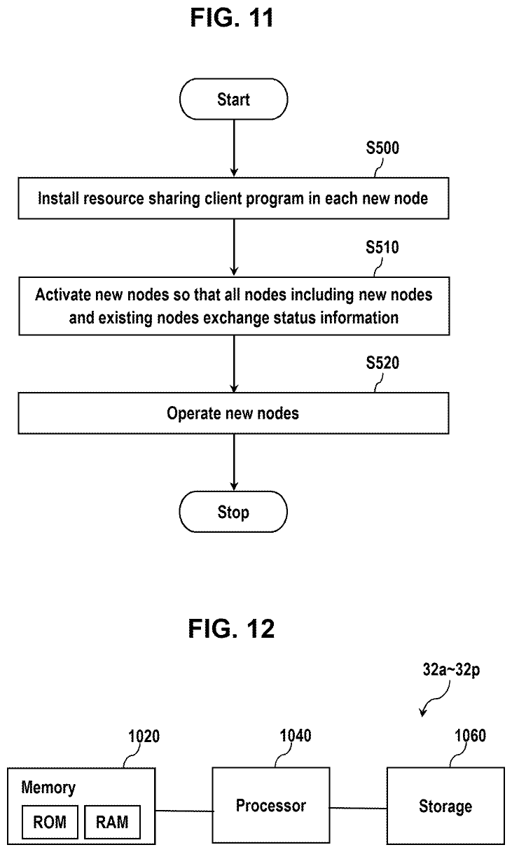

In detail, as shown in FIG. 11 which shows a process of expanding the broker network 30 according to an addition of new nodes, the resource sharing client program for implementing the present disclosure is first installed in each of the new nodes (step 500). At this time, it may not be necessary to install a separate program to each of the producers 10A-10N or the consumers 20A-20M.

After the status of new nodes are checked, the new nodes are activated so that status information of the new nodes and existing nodes are propagated through the broker network 30 (step 510). Then, all the nodes including the new nodes are operated to perform their functions (step 520).

When additional nodes join in the network, the analysis of requirements for data sharing is unnecessary as described above. Thus, according to the present disclosure, new nodes can be added very easily into the network. Even when two systems are to be interfaced, there is no need to build a new infrastructure or analyze infrastructures of the two systems, and an interfacing can be easily accomplished by sharing the status information among the nodes.

FIG. 12 is a physical block diagram of each of the nodes 32A-32P according to an embodiment of the present disclosure.

Referring to FIG. 12, each of the nodes 32A-32P according to an embodiment of the present disclosure may include at least one processor 1020, a memory 1040, and a storage 1060.

The processor 1020 may execute program instructions stored in the memory 1020 and/or the storage 1060. The processor 1020 may be a central processing unit (CPU), a graphics processing unit (GPU), or another kind of dedicated processor suitable for performing the methods of the present disclosure.

The memory 1040 may include, for example, a volatile memory such as a read only memory (ROM) and a nonvolatile memory such as a random access memory (RAM). The memory 1040 may load the program instructions stored in the storage 1060 to provide to the processor 1020.

The storage 1060 may include an intangible recording medium suitable for storing the program instructions, data files, data structures, and a combination thereof. Any device capable of storing data that may be readable by a computer system may be used for the storage. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

The storage 1060 may store the program instructions. In particular, the program instructions may include a resource sharing client program according to the present disclosure. The resource sharing client program may include program instructions necessary for implementing the delivery and operation unit 100 and the scheduling engine 140 illustrated in FIGS. 4 and 6. Such program instructions may be executed by the processor 1020 in a state of being loaded into the memory 1040 under the control of the processor 1020 to implement the method according to the present disclosure.

As mentioned above, the apparatus and method according to exemplary embodiments of the present disclosure can be implemented by computer-readable program codes or instructions stored on a computer-readable intangible recording medium. The computer-readable recording medium includes all types of recording media storing data readable by a computer system. The computer-readable recording medium may be distributed over computer systems connected through a network so that a computer-readable program or code may be stored and executed in a distributed manner.

The computer-readable recording medium may include a hardware device specially configured to store and execute program commands, such as ROM, RAM, and flash memory. The program commands may include not only machine language codes such as those produced by a compiler, but also high-level language codes executable by a computer using an interpreter or the like.

Some aspects of the present disclosure have been described above in the context of a device but may be described using a method corresponding thereto. Here, blocks or the device corresponds to operations of the method or characteristics of the operations of the method. Similarly, aspects of the present disclosure described above in the context of a method may be described using blocks or items corresponding thereto or characteristics of a device corresponding thereto. Some or all of the operations of the method may be performed, for example, by (or using) a hardware device such as a microprocessor, a programmable computer or an electronic circuit. In some exemplary embodiments, at least one of most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

While the present disclosure has been described above with respect to embodiments thereof, it would be understood by those of ordinary skill in the art that various changes and modifications may be made without departing from the technical conception and scope of the present disclosure defined in the following claims.

1. In a real-time data transmission system having a plurality of resource sharing control node devices to deliver transmit data provided by a data producer to a data consumer, through at least some of the plurality of resource sharing control node devices, a resource sharing control node device comprising:
a processor; and
a memory storing at least one instruction to be executed by the processor,
wherein the at least one instruction when executed by the processor causes the processor to:
decompose an operation that should be performed on the transmit data into a plurality of partial operations;
establish a delivery path passing a portion of other resource sharing control node devices in the real-time data transmission system and through which the transmit data is to be delivered to the data consumer; allocate the partial operations to two or more resource sharing control node devices on the delivery path, so that the operation that should be performed on the transmit data is performed by the two or more resource sharing control node devices on the delivery path during a real-time delivery of the transmit data; and
perform one partial operation allocated by one of other resource sharing control node devices on the transmit data to output an operation result to the data consumer device or another resource sharing control node device.

2. (canceled)

3. The resource sharing control node device of claim 1, wherein the at least one instruction causing the processor to establish the delivery path includes instructions to:
establish the delivery path such that a distance from the producer device and the consumer device is minimized.

4. The resource sharing control node device of claim 1, wherein the at least one instruction causing the processor to establish the delivery path includes instructions to:
check status information of other nearby resource sharing control node devices; and
establish the delivery path based on the status information.

5. The resource sharing control node device of claim 1, wherein the at least one instruction causing the processor to establish the delivery path includes instructions to:
check delays in other nearby resource sharing control node devices; and
establish the delivery path such that the delays are minimized.

6. The resource sharing control node device of claim 1, wherein the at least one instruction causing the processor to allocate each of the partial operations includes instructions to:
allocate the partial operations to two or more resource sharing control node devices on the delivery path such that duplicate operations in the real-time data transmission system are minimized.

7. The resource sharing control node device of claim 6, wherein the at least one instruction causing the processor to allocate the partial operations includes instructions to: receive a request for registration of the operation from the consumer device.

8. The resource sharing control node device of claim 6, wherein the at least one instruction comprises:
instructions when executed by the processor causes the processor to:
adjust the delivery path and the allocation result to optimize the delivery path and the allocation result after allocating the partial operations to the the two or more resource sharing control node devices.

9. The resource sharing control node device of claim 1, wherein the at least one instruction comprises:
instructions when executed by the processor causes the processor to:
collecting status information of nearby resource sharing control node devices; and
share the status information with other resource sharing control node devices.

10. In a real-time data transmission system having a plurality of resource sharing control node devices to deliver transmit data provided by a data producer to a data consumer through at least some of the plurality of resource sharing control node devices, a resource sharing control method, performed by each of the plurality of resource sharing control node devices, comprising:
(a) determining resources required for handling the transmit data;
(b) decomposing an operation that should be performed on the transmit data into a plurality of partial operations;
(c) establishing a delivery path passing a portion of
other resource sharing control node devices in the real-time data transmission system and through which the transmit data is to be delivered to the data consumer; allocating the partial operations to two or more resource sharing control node devices on the delivery path so that the operation that should be performed on the transit data is performed by the two or more resource sharing control node devices on the delivery path during a real-time delivery of the transmit data; and
(e) performing one partial operation allocated by one of other resource sharing control node devices on the transmit data to output an operation result to the data consumer device or another resource sharing control node device.

11. (canceled)

12. The resource sharing control method of claim 10, wherein, in the step (c), the delivery path is established such that a distance from the producer device and the consumer device is minimized.

13. The resource sharing control method of claim 10, wherein the step (c) comprises:
checking status information of other nearby resource sharing control node devices; and
establishing the delivery path based on the status information.

14. The resource sharing control method of claim 10, wherein the step (c) comprises:
checking delays in other nearby resource sharing control node devices; and
establishing the delivery path such that the delays are minimized.

15. The resource sharing control method of claim 10, wherein, in the step (d), the partial operations are allocated to the two or more resource sharing control node devices on the delivery path such that duplicate operations in the real-time data transmission system are minimized.

16. The resource sharing control method of claim 15, further comprising:
(f) adjusting the delivery path and an allocation result to optimize the delivery path and the allocation result.

17. The resource sharing control method of claim 10, wherein the step (d) comprises:
receiving a request for registration of the operation from the consumer device.
